(19) United States
(12) Patent Application Publication
(10) Pub. No.: US 2003/0225533 A1
(43) Pub. Date: Dec. 4, 2003

(54) METHOD OF DETECTING A BOUNDARY OF A FLUID FLOWING THROUGH A PIPE

(76) Inventors: Reginald Alfred King, Shrivenham (GB); Richard Donald Hughes, Swindon (GB); Graydon Mark Rodwell, Faringdon (GB); Annabel Clifton, Malmesbury (GB)

Correspondence Address: David M. Carter, CARTER, DELUCA, FARRELL & SCHMIDT, LLP, Suite 225, 445 Broad Hollow Road, Melville, NY, 11747, US

(21) Appl. No.: 10/160,841

(22) Filed: Jun. 3, 2002

(51) Int. Cl. G01N 15/06

(52) U.S. Cl. 702/50; 73/61.71

(57) ABSTRACT

A method of detecting a boundary of fluid flowing through a pipe, the method comprising receiving a time-varying signal corresponding to changes in content flowing through the pipe analysing said signal in the time domain, said analysing including processing said signal to produce a processed signal, searching said processed signal for a predetermined feature so as to identify a location of said boundary if said predetermined feature is found.

### FIELD OF THE INVENTION

The present invention relates to a method of detecting a boundary of a fluid flowing through a pipe particularly but not exclusively to a method of detecting a slug in a pipeline.

### BACKGROUND ART

The development of slugs in the oil, gas and water liquid mixture flow in multi-phase pipelines is a major and expensive problem for all oil producers. In particular, the development of slugs of liquid in the riser of multi-phase pipelines of an oil platform has a negative impact on the operation of offshore production facilities. Severe slugging can cause pollution, platform trips and plant shut down. In general, large and rapid flow changes cause overload of the fixed size catcher and separator resulting in spillage and pollution, unwanted flaring and reduce the operating capacity of the separation and compression units. This results from the relative small size of the catcher, often only 25 to 500 barrels, the need to allow larger margins for the fixed size separator, to meet the product specification, and the compression unit and to ensure safe operation with minimal flaring. Reducing the output of an oil rig or platform from its optimum for any or all of these in order to accommodate slugging flow reduces its output at the expense of revenue.

The slug flow starts with oil and water accumulating in the well. Gas collects behind a growing slug causing an increase in pressure such that the slug is forced to move followed by the gas. This flow appears in the horizontal pipeline as an intermittent, accelerating, concentrated mass which leaves the riser and accelerates/travels along the horizontal multi-phase flow pipeline to the limited size catcher and beyond.

Real time detection of slugs in their various forms has proved to be extremely difficult. The density of the pipeline contents can be measured continuously, resulting in a data stream, using a gamma ray densitometer. However, the detection of the front and rear of passing slugs within the pipeline flow, and therefore the density data streams, has previously proved an intractable problem.

The present invention seeks to provide a method of detecting slugs and thus help improve slug catching.

### SUMMARY OF THE INVENTION

According to the present invention as provided a method of detecting a boundary of fluid flowing through a pipe, a method comprising receiving a time-varying signal corresponding to changes in content flowing through the pipe, analysing the signal in the time domain, the analysing including processing the signal to produce a processed signal, searching the processed signal for a predetermined feature so as to identify a location of the boundary if the predetermined feature is found.

The method may further comprise receiving another signal corresponding to changes in content flowing through the pipe, analysing the signal in a time domain the analysing including processing the another signal to produce another process signal, searching the another process signal for another predetermined feature so as to identify another location of the boundary if the another predetermined feature is found. The receiving of the signal and the another signal may comprise arranging first and second devices for producing the signals at positions along the pipe separated by a known distance.

The method may further comprise deriving a velocity of the boundary of the fluid from the first and second locations. Processing the signal may comprise amplifying the signal to produce an amplified signal, smoothing the amplified signal to produce a smooth signal, differentiating the smooth signal to produce a differentiated signal, further amplifying the differentiated signal to produce a processed signal. A further amplifying the differentiated signal may comprise squaring the differentiated signal while preserving a sign of the differentiated signal. Searching for the predetermined feature may include identifying locations where the processed signal has zero amplitude. Searching for the predetermined feature may include dividing the processed signal into periods between the locations where the processed signal has zero amplitude and determining a maximum magnitude value for the processed signal in each respective period. Searching for the predetermined feature may include determining a mean and a standard deviation of the maximum magnitude values and identifying which of the maximum magnitude values exceed the sum of the mean and standard deviation. The method may further comprise identifying a first boundary if the predetermined feature is found. The method may further comprise determining whether the first boundary is found within a predetermined time window and whether the first boundary meets a predefined set of criteria. The method may further comprise searching for a second predetermined feature and may include determining a threshold value and identifying where the magnitude of the signal exceeds the threshold magnitude. The method may comprise identifying a second boundary if the second predetermined feature is found. The method may further comprise determining whether the second boundary receives the first boundary. The signal may comprise converting an analogue signal into a digital signal and buffering samples of the digital signal. The analysing of the signal may comprise using a time-encoded signal processing and recognition (TESPAR) process.

Processing the signal may comprise filtering the signal to produce a filtered signal, for example by using a Savitzky Golay filter. Processing the signal may comprise subtracting an offset from the filtered signal so as to produce a signal for zero-crossing analysis. Searching the processed signal for a predetermined feature may include identifying locations where the signal has zero amplitude. Searching for a predetermined feature may include identifying locations where the signal has zero amplitude. Searching for the predetermined feature may further include identifying whether the signal is going from negative to positive. Identifying the location may comprise identifying a first boundary if the predetermined feature is found. The method may further comprise in determining whether the first boundary is found within the predetermined time window and whether the first boundary meets a predefined set of criteria. The method may comprise searching for a second predetermined feature that may comprise identifying the locations has zero amplitude and identifying a second boundary if the second predetermined feature is found. The method may further comprise determining whether the second boundary receives the first boundary. Searching for said predetermined feature may further include identifying whether the signal is going from positive to negative.

Processing the signal may include determining a distribution of magnitudes of the signal. Processing the signal may include filtering the diffuser filter signal such as linear filtering and low pass filtering. Filtering may comprise using a low pass 8^{th} order Butterworth filter with a 0.5 Hz cut-off. Processing the signal may include determining a distribution of magnitude of the filtered signal. Processing the signal may include determining an off set for converting the distribution from being unipolar to being bipolar. Processing the signal may include subtracting the offset from the filtered signal to produce an offset signal. Processing the signal may include filtering the offset signal for example using a non-linear filter, in particular a 10^{th} order non-linear filter. Processing of the signal to produce a processed signal may comprise removing features from the filtered signal having a short time duration. Removing the features from the filtered may comprise searching the filtered signal and identifying locations where the signal has zero amplitude. Removing the features further includes determining the duration between adjacent locations where the signal has zero amplitude. Removing the features further includes determining sign and amplitude of a signal portion between adjacent locations and adding a further signal of opposite sign and same magnitude to the signal portion if the adjacent locations are separated by less than a predetermined duration. Searching the processed signal for the predetermined feature includes identifying locations where the signal has zero amplitude. Searching for said predetermined feature may further include identifying whether the signal whether the signal is going from negative to positive. Identifying the location may comprise identifying a first boundary if said predetermined feature is found. The method may further comprise determining whether the first boundary is found within a predetermined time window. The method may further comprise determining whether the first boundary is a predetermined set of criteria. The method may comprise searching for a second predetermined feature for example by identifying the locations where the signal has zero amplitude.

According to the present invention, there is also provided a computer program for executing the method.

According to the present invention, there is also provided apparatus for detecting a boundary of fluid flowing through a pipe, the method comprising input for receiving a time-varying signal corresponding to changes in content flowing through the pipe and a processor for analysing said signal in the time domain, the processor being configured to produce a processed signal, to search the processed signal for a predetermined feature and identify a location of the boundary if said predetermined feature is found.

### BRIEF DESCRIPTION OF THE DRAWINGS

An embodiment of the present invention will now be described, by way of example, with reference to the following drawings in which:

FIG. 1 is a schematic diagram of an oil production facility;

FIG. 2 is a side view of a measurement apparatus and shows the pipeline in cross section;

FIG. 3 shows an end view of the measurement apparatus and shows the pipeline in cross section;

FIG. 4 is a schematic diagram of analyser apparatus;

FIG. 5 shows a window displayed by the analyser apparatus;

FIG. 6 is a processed flow diagram for initialising and running the analyser apparatus;

FIG. 7 is a processed flow diagram for analysing data in a first manner;

FIG. 8 shows a processed signal prior to being analysed;

FIG. 9 illustrates identification of magnitude values for a plurality of epox;

FIG. 10 is a processed flow diagram for analysing data in a second manner;

FIG. 11 illustrates a signal;

FIG. 12 illustrates a signal from which an offset has been subtracted;

FIG. 13 shows zero crossings;

FIG. 14 is a processed flow diagram for analysing data according to a third manner;

FIG. 15 shows a signal;

FIG. 16 shows a distribution and magnitudes of the signal;

FIG. 17 shows a frequency plot of said signal following filtering;

FIG. 18 shows a filtered signal;

FIG. 19 shows a distribution of magnitudes of the filtered signal;

FIG. 20 shows a filtered signal to which an offset has been added;

FIG. 21 shows a non-linear filtered signal;

FIG. 22 shows a distribution of magnitudes of the signal shown in FIG. 21;

FIG. 23 shows the non-linearly filtered signal of FIG. 21 following removal of features having a short duration and

FIG. 24 shows another non-linearly filtered signal obtained from a different signal.

### PREFERRED EMBODIMENT OF THE INVENTION

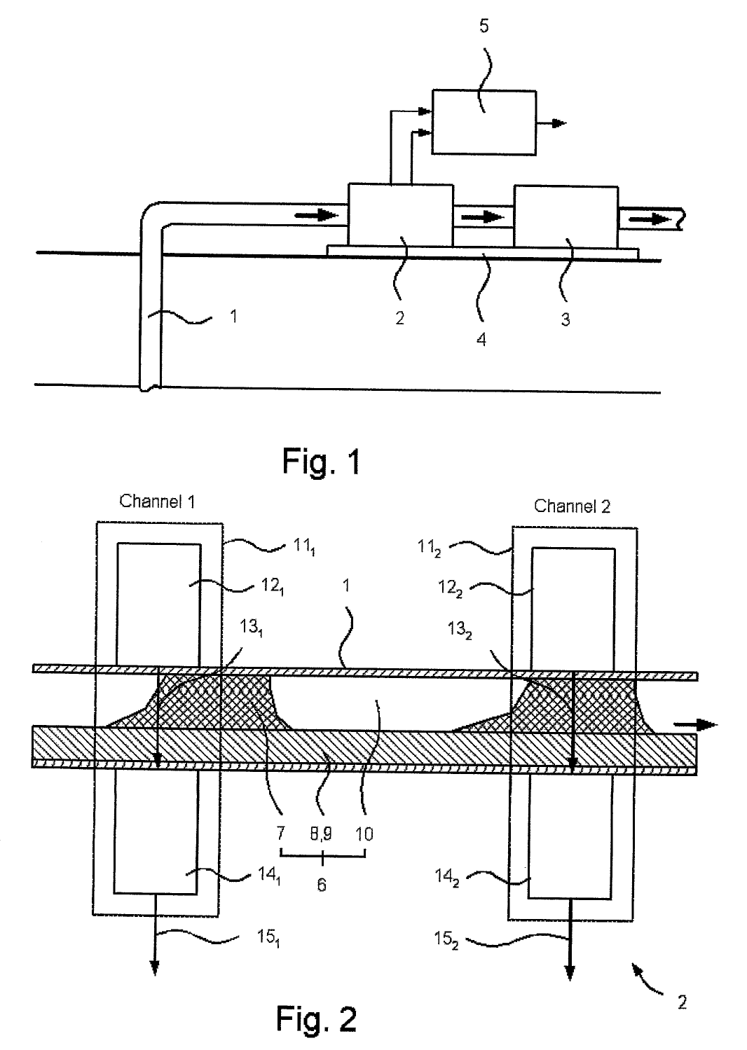

Referring to FIG. 1, a pipeline 1 connects a well (not shown) to an oil receiving facility which includes measurement apparatus 2 and capture tank 3 for catching slugs. The measurement apparatus 2 and capture tank 3 are located on a platform 4 such as an oil rig or recovery vessel. Analyser apparatus 5 is also provided to receive signals from the measurement apparatus 2 so to provide control signals for reporting the state of the capture tank 3.

Referring to FIG. 2, the measurement apparatus 2 is used to measure changes in content 6 flowing through the pipeline 1. A common problem is the appearance of slugs 7 in a multiphase mixture of oil 8 and water 9, and gas 10.

To measure changes in the contents flowing through the pipe first and second measurement devices 11₁, 11₂ are employed. In this example, the measurement devices 11₁, 11₂ are in the form of gamma ray (γ-ray) densitometers. Each measurement device 11₁, 11₂ comprises a respective source 12₁, 12₂ of γ-rays, which produces a beam 13₁, 13₂ of γ-rays that pass through the pipe 1 and pipe contents 6. The beams 13₁, 13₂ are attenuated by the pipe 1 and the pipe contents 6. The beams 13₁, 13₂ are picked up by respective detectors 14₁, 14₂ which produce respective time-varying signals 15₁, 15₂.

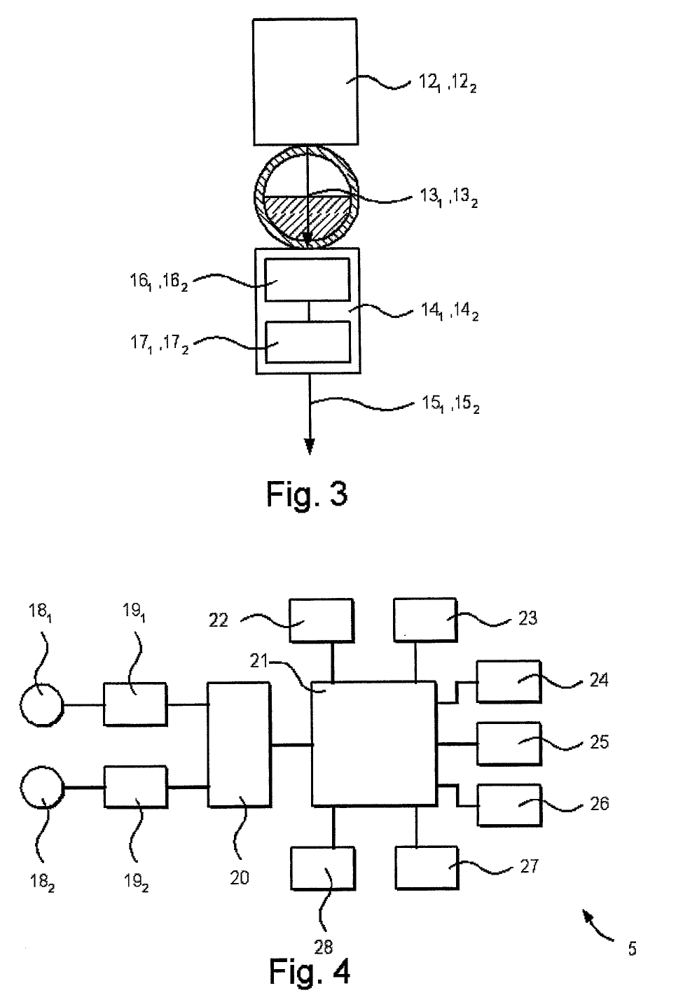

Referring to FIG. 3, each detector 14₁, 14₂ comprises a respective receiver 16₁, 16₂ whose output is amplified using an amplifier 17₁, 17₂.

Referring to FIG. 4, the signals 15₁, 15₂ from the measurement devices 11₁, 11₂ are fed into the analysing apparatus 5 via ports 18₁, 18₂. The signals 15₁, 15₂ are fed through filters 19₁, 19₂ to a multi-channel analog-to-digital converter card 20 which samples of the signals 15₁, 15₂ and feeds the samples to a processor 21. The analyser apparatus 5 further includes random access memory (RAM) 22, flash memory 23, a channel output control 24 for providing an estimate of slug volume, a display 25, in the form of a monitor, a user input 26, preferably in the form of a keyboard and mouse, an output 27, in the form of an RS-232 port, and storage medium 28, such as a hard disk.

In this example, the analysing apparatus 5 is in the form of a personal computer executing a computer program for performing a method of slug detection. However, dedicated hardware may be used.

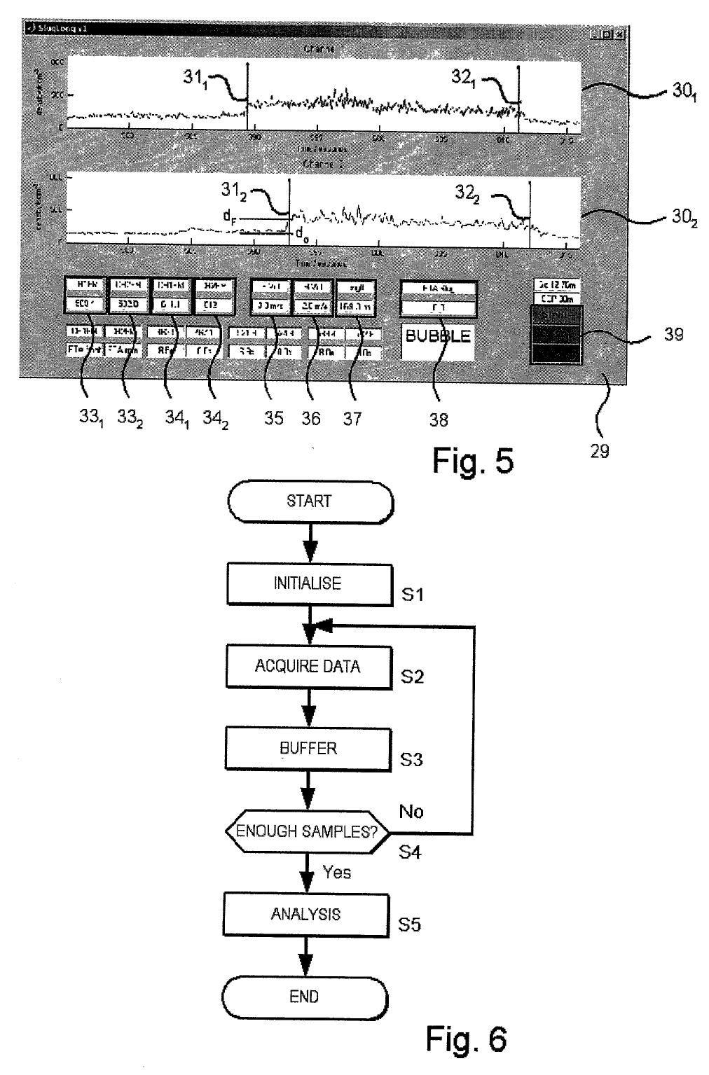

Referring to FIG. 5, the analysing apparatus includes a graphical user interface in the form of a window 29 which is displayed on the monitor 25. The window 29 includes graphical representations 30₁, 30₂ of the signals 15₁, 15₂ (FIG. 2). Each graphical representation 30₁, 30₂ includes markers 31₁, 31₂ for indicating a front of a slug passing each measurement device 11₁, 11₂ (FIG. 2) and markers 32₁, 32₂ for indicating an end of a slug.

The window 29 displays slug parameters including positions 33₁, 33₂, 34₁, 34₂ of the markers 31₁, 31₂, 32₁, 32₂, velocities 35, 36 of the front and end of the slug, length 37 of the slug and estimated time of arrival (ETA) 38 of the slug at catcher 3 (FIG. 1). Four values of slug length are computed using the 33₁, 33₂, 34₁, 34₂ of the markers 31₁, 31₂, 32₁, 32₂, together with a value of slug velocity. The window 29 includes control buttons 39 for starting and stopping analysis.

Values for estimated time of arrival (ETA) 38 of the slug and slug volume are supplied as digital signals to a serial port 27 and to the control output 24 via a digital-to-analog output (not shown) with a 20 mA loop interface.

Referring to FIG. 6, a process for logging samples of the signals 15₁, 15₂ and analysing the signals 15₁, 15₂ so as to detect locations of front and end of a slug 7 (FIG. 2) and compute slug parameters is shown.

A user starts the process and the analyser apparatus 5 (FIG. 1) is initialised, for example by clearing buffers and resetting software flags (step S1).

A period of “running-in” occurs. The analyser apparatus 5 receives signals 15₁, 15₂ from the measurement devices 11₁, 11₂ (FIG. 2) and samples them at known rate (step S2). In this example, the sampling rate is 10 samples per second.

Referring also to FIG. 7, samples 15₁′, 15₂′ of the signals 15₁, 15₂ are stored in first and second buffers 40₁, 40₂ respectively (step s3). In this example, each buffer 40₁, 40₂ is able to store 3,000 samples and is configured in a so-called “first in, first out” (FIFO) arrangement. The process continues until each buffer 40₁, 40₂ is filled (step S4). Once the buffers 40₁, 40₂ are filled, then analysis of the signals 15₁, 15₂ can begin (step S5).

Three different processes for detecting slugs may be used. Preferably, all three processes are used, although results of one of the processes may be selected and used.

Differentiated Waveform Process

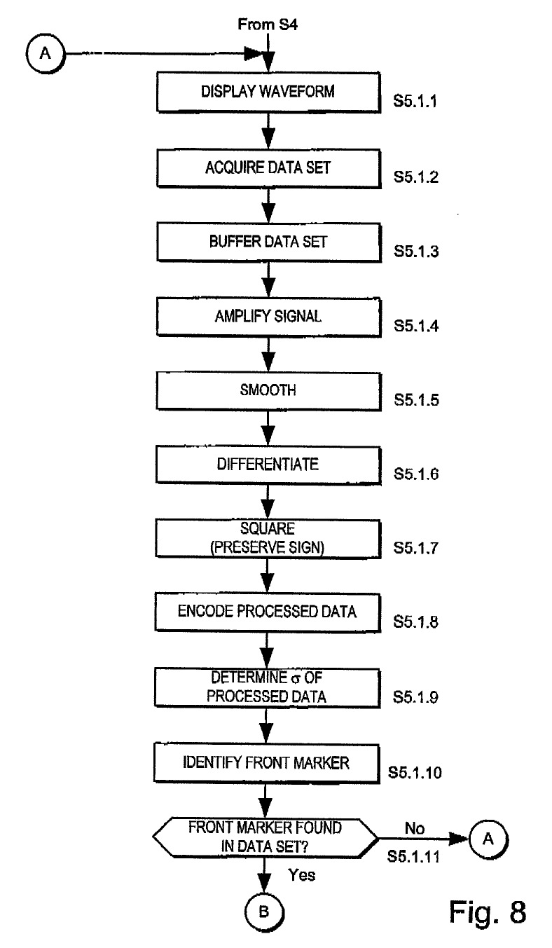

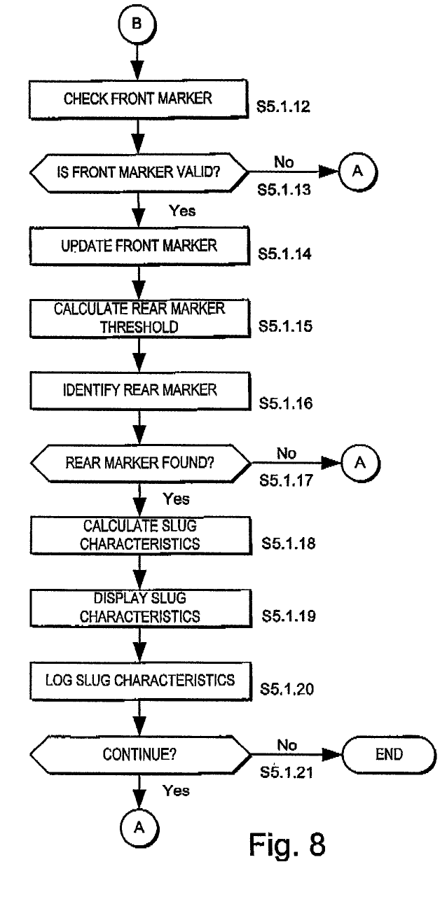

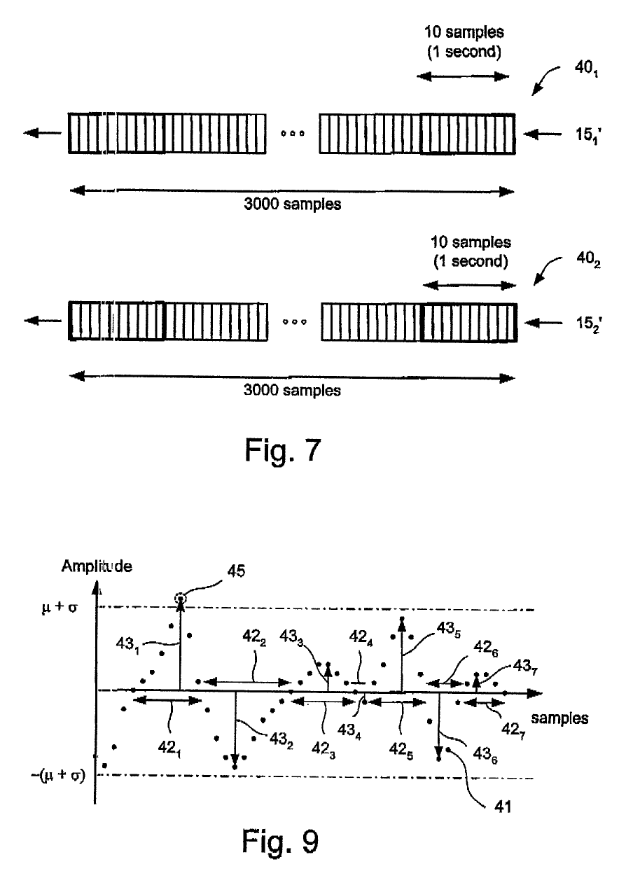

Referring to FIG. 8, a first process for detecting slugs is shown:

For each signal 15₁, 15₂, a graphical representation 30₁, 30₂ is displayed (step S5.1.1). A further predetermined number of samples 15₁′, 15₂′ of the signals 15₁, 15₂, herein referred to as a data set, are acquired and added to the front of each respective buffer 40₁, 40₂ (steps S5.1.2 & S5.1.3). A corresponding number of samples are deleted from the end of each buffer 40₁, 40₂. In this example, the data set comprises 10 samples corresponding to 1 second.

For each buffer 40₁, 40₂, the signals 15₁, 15₂ are processed before slug detection occurs.

Each signal 15₁, 15₂ is amplified, in this case by a factor of 1,000, to produce a corresponding amplified signal (step S5.1.4). The amplified signal is then smoothed to produce a smoothed signal (step S5.1.5). The smoothed signal is differentiated to produce a differentiated signal (step S5.1.6). The differentiated signal is then non-linearly amplified, in this case by squaring the differentiated signal and preserving its sign (step S5.1.7). The result is a processed signal suitable for searching for features which correspond to and which identify slug boundaries.

Referring to FIG. 9, each processed signal comprises a plurality of samples 41, in this case 3000. The processed signal is examined to identify locations where it crosses the sample axis, in other words to identify so-called “zero crossings”. The processed signal is divided into periods 42₁, 42₂, 42₃, 42₄, 42₅, herein referred to as epochs, between the zero crossings. For each epoch 42₁, 42₂, 42₃, 42₄, 42₅, a maximum magnitude value 43₁, 43₂, 43₃, 43₄, 43₅ is determined. This is performed using a time encoded signal processing and recognition (TESPAR) process.

A description of the TESPAR process is found in GB-A-2145864, which is incorporated herein by reference.

For each processed signal, a probability distribution function, for example a Gaussian distribution, is used to determine a standard deviation δ (step S5.1.9), i.e., the set of epoch amplitudes that lie within 95% of the total set.

Each processed signal is examined for predefined features which are indicative of a slug boundary.

To identify a front of a slug, a search is made for epochs 42₁, 42₂, 42₃, 42₄, 42₅ whose maximum magnitude value 43₁, 43₂, 43₃, 43₄, 43₅ fall outside one standard deviation, i.e. whose absolute values |s|>|δ|. In FIG. 9, one such sample 45 is shown whose value 43₁, falls outside one standard deviation.

Each sample 45 whose value 43 falls outside one standard deviation and is positive is considered to be a front of a slug (step S5.1.10).

A check is made whether the samples 45 corresponding to a front of a slug are found within a predetermined window of time (step S5.1.11). In this example, the predetermined window of time corresponds to the latest 10 samples acquired. If no samples 45 corresponding to a front of a slug are found in the predetermined window, then process returns to step S5.1.1 where the graphical representation 30₁, 30₂ (FIG. 5) are updated. Otherwise, the front of the slug is marked.

For each signal 15₁, 15₂, checks are made as to whether the front marker is valid (S5.1.12). For example, the front marker is checked to ensure that it is later in time than the currently held front markers. If the front marker is not later in time than the current marker then it is discarded. If the front marker is found to be within half a second of the currently held front marker, then the front marker is also checked to see whether the amplitude of the sample 15′ corresponding to the front marker, i.e. the measured density at the front of the slug, is greater than the amplitude of the sample corresponding to the current held front marker. If the front marker is found to be valid, then it becomes a new current marker (S5.1.14), otherwise the process returns to step S5.1.1.

For each signal 15₁, 15₂, a threshold density is calculated. The threshold density dₜₕₑₛₕ is defined as being 60% of a difference between the density d₀ which lies in front of the slug, referred to as the “slug front porch density”, and the density d_{F} at the front of the slug, referred to as the “front marker density”.

Using a corresponding value of threshold density, each signal 15₁, 15₂ is searched to find the rear of the slug (step S5.1.16). The search may be limited to a predetermined window, for example, the latest 10 samples. If no rear of the slug is identified then the process returns to step S5.1.1. If the rear of the slug is found, then the sample location becomes the rear marker. However, the rear marker may be checked. For example, if a constraint is placed that the rear marker must be found within the latest 10 samples, then the additional check comprises determining the mean values for the first 5 samples and the second 5 samples. If both calculated values of mean are below the 60% threshold dₜₕₑₛₕ and the two subsequent means have a negative slope, then the rear marker is valid.

Steps S5.1.1 to steps S5.1.17 are performed in respect of each signal 15₁, 15₂ to find front and end markers 31₁, 31₂, 32₁, 32₂ (FIG. 5). Once front and rear markers 31₁, 31₂, 32₁, 32₂ have been identified, then slug characteristics can be computed (S5.1.18).

For example, if the front of the slug is determined to be at time t₁ for the first signal 15₁ and the front of the slug is determined at time t₂ for the first signal 15₁ and the measurement devices 11₁, 11₂ are separated by a known distance D, then the velocity v_{F} of the front of the slug 7 may be calculated using:

$${v}_{F} = \frac{D}{{t}_{1} - {t}_{2}} \qquad ( 1 )$$

Similarly, if the end of the slug for the first signal 15₁ occurs at time t₃ and the end of the slug occurs at time t₄ for a signal 15₂, then the velocity of v_{R} for the rear of the slug is defined as:

$${v}_{R} = \frac{D}{{t}_{3} - {t}_{4}} \qquad ( 2 )$$

The length L of the slug is determined by calculating lengths L₁, L₂, L₃, L₄ of the slug using t₁, t₂, t₃, t₄, v_{F}, v_{R} using:

L₁=v_{F}(t₃−t₁) (3a)

L₂=v_{F}(t₄−t₂) (3b)

L₃=v_{R}(t₃−t₁) (3c)

L₄=v_{R}(t₄−t₂) (3d)

and then:

$$L = \frac{{L}_{1} + {L}_{2} + {L}_{3} + {L}_{4}}{4} \qquad ( 4 )$$

An estimated time T of arrival is calculated using:

$$T = \frac{1}{{v}_{F}} S \qquad ( 5 )$$

where S is the distance between the measurement apparatus 2 and the separator 3.

The slug characteristics 33₁, 33₂, 34₁, 34₂, 35, 36, 37, 38 (FIG. 5) are displayed and are also logged onto disk 28, for example in ASCII format together with a header file (FIG. 4) (steps S5.1.19 & S5.1.20)

A check is made whether the stop button 39 (FIG. 5) has been pressed (step S5.1.21). If the stop button has been pressed, indicating that the user no longer wishes to continue, then the process ends. Otherwise, the process returns to S5.1.1 where the signals 15₁, 15₂ are updated.

The slug volume can be used to control an input control valve (not shown) to the catcher 3 to prevent the catcher from overflowing.

Whole Waveform Process

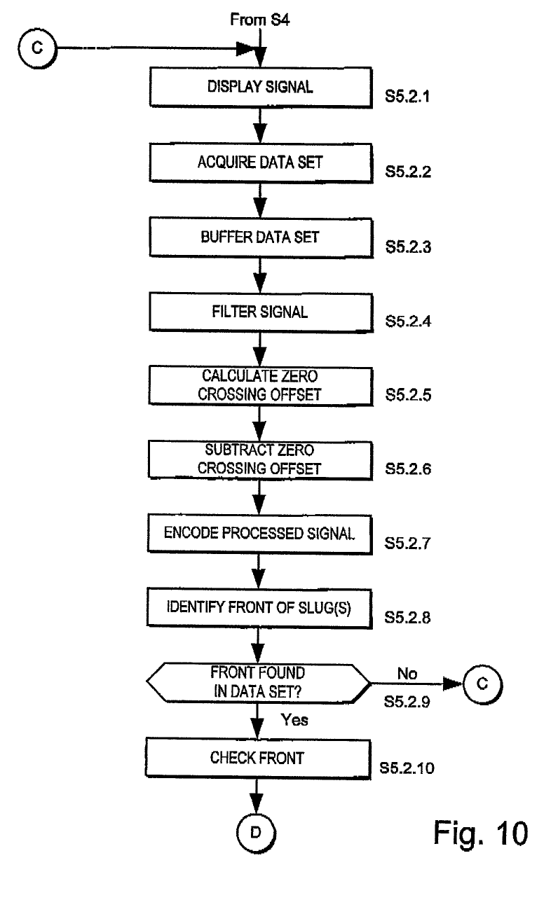

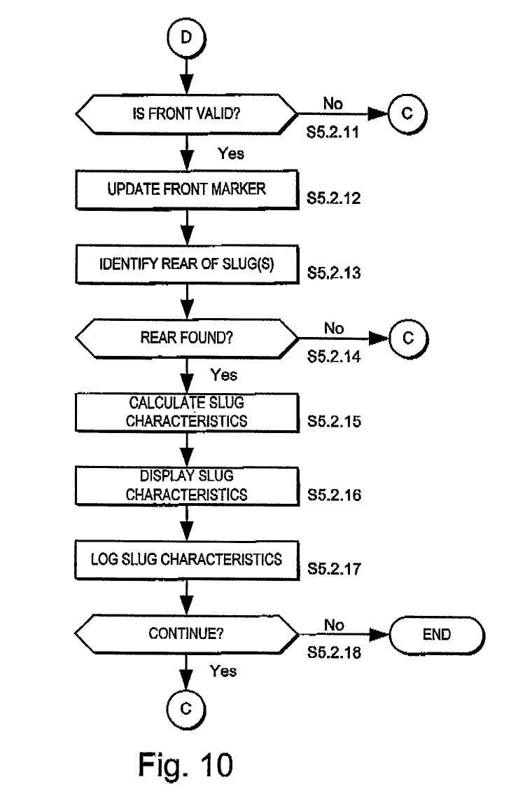

Referring to FIG. 10, a second process for detecting slugs is shown:

For each signal 15₁, 15₂, a graphical representation 30₁, 30₂ is displayed (step S5.2.1). A further predetermined number of samples 15₁′, 15₂′ of the signals 15₁, 15₂, herein referred to as a data set, are acquired and added to the end of each respective buffer 40₁, 40₂ (steps S5.2.2 & S5.2.3). A corresponding number of samples are deleted from the front of each buffer 40₁, 40₂. In this example, the data set comprises 10 samples.

For each buffer 40₁, 40₂, the signals 15₁, 15₂ are processed before slug detection occurs.

Each signal 15₁, 15₂ is filtered using a Savitzky Golay filter (step S5.2.4). The Savitzky Golay filter has the advantage of reducing noise, while preserving features of interest. The Savitzky Golay filter is described in more detail in Section 8.3.5 in “Introduction to Signal Processing” by Sophocles J. Orfanidis, p434 (Prentice Hall) [ISBN 0-13-209172-0].

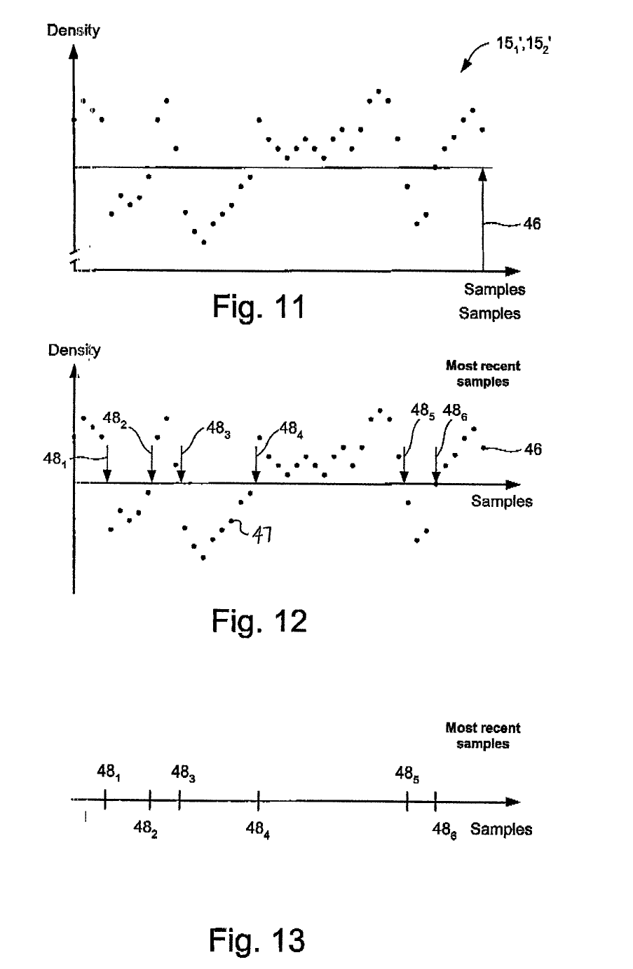

Referring to FIGS. 11 and 12, for each signal 15₁, 15₂, a density offset 46 is calculated (step S5.2.5) which is subtracted from the filtered signal.

A method of calculating the density offset 46 will now be described:

A base level threshold zx is calculated by taking the mean of the samples z in a buffer 40₁, 40₂, which may be described in pseudo-code as:

zx=mean(buf) where buf is the contents of the buffer

A deviation from the mean pv from the value zx is then calculated by taking the mean of the values z-zx, for values of z which are greater than zx, i.e.:

pv=mean(buf(find(buf>=zx) )−zx)

A deviation from the mean nv from the value zx is then calculated by taking the mean of the values zx−z, for values z which are less than zx, i.e.:

nv=mean(zx−buf(find(buf<zx)))

The offset zz 46 is calculated by subtracting the mean deviation nv from the base threshold zx and adding the average value of the deviations pv and nv, in other words:

zz=zx−nv+( (nv+pv)*0.5)

The result is a processed signal suitable for searching for features which correspond to and which identify slug boundaries.

Referring to FIGS. 12 and 13, each processed signal comprises a plurality of samples 47, in this case 3000. The processed signal is examined to identify locations 48₁, 48₂, 48₃, 48₄, 48₅, 48₆ where it has zero amplitude, in other words to identify so-called “zero crossings”. This is performed using a time encoded signal processing and recognition (TESPAR) process.

A description of a TESPAR process is found in GB-A-2145864, which is incorporated herein by reference.

To identify a front of a slug, a search is made for zero crossings 48₁, 48₂, 48₃, 48₄, 48₅,48₆ which positive going, in other words crossing negative to positive in the direction of time (step S5.2.8). In FIG. 12, zero crossings 48₂, 48₄, 48₆ are considered to be a front of a slug

A check is made whether the zero crossings 48₂, 48₄, 48₆ are found within a predetermined window of time (step S5.2.9). In this example, the predetermined window of time corresponds to the latest ₁₀ samples acquired. If no zero crossings 48₂, 48₄, 48₆ are found in the predetermined window, then process returns to step S5.2.1 where the graphical representation 30₁, 30₂ (FIG. 5) are updated. Otherwise, the front of the slug is marked

For each signal 15₁, 15₂, checks are made as to whether the front marker is valid (step S5.2.10 & S5.2.11). For example, the front marker is checked to ensure that it is later in time than the currently held front markers. If the front marker is not later in time than the current marker then it is discarded. If the front marker is found to be within half a second of the currently held front marker, then the front marker is also checked to see whether the amplitude of the sample 15′ corresponding to the front marker, i.e. the measured density at the front of the slug, is greater than the amplitude of the sample corresponding to the current held front marker. If the front marker is found to be valid, then it becomes a new current marker (step S5.2.12), otherwise the process returns to step S5.1.1.

To identify an end of a slug, a search is made for zero crossings 48₁, 48₂, 48₃, 48₄, 48₅, 48₆ which are negative going. (step S5.2.13). The search may be limited to a predetermined window, for example, the latest 10 samples. If no rear of the slug is identified then the process returns to step S5.2.1. If the rear of the slug is found, then the sample location becomes the rear marker. However, the rear marker may be checked. For example, if a constraint is placed that the rear marker must be found within the latest 10 samples, then the additional check comprises determining the mean values for the first 5 samples and the second 5 samples. If both calculated values of mean are below the 60% threshold dₜₕₑₛₕ, then the rear marker is valid in a manner described earlier.

Steps S5.2.1 to steps S5.2.17 are performed in respect of each signal 15₁, 15₂ to find front and end markers 31₁, 31₂, 32₁, 32₂ (FIG. 5). Once front and end markers 31₁, 31₂, 32₁, 32₂ have been identified, then slug characteristics can be computed (S5.2.15) in a manner hereinbefore described.

The slug characteristics 33₁, 33₂, 34₁, 34₂, 35, 36, 37, 38 (FIG. 5) are displayed and are also logged onto disk 28, for example in ASCII format together with a header file (FIG. 4) (steps S5.2.16 & S5.2.17)

A check is made whether the stop button 39 (FIG. 5) has been pressed (step S5.2.18). If the stop button has been pressed, indicating that the user no longer wish to continue, then the process ends. Otherwise, the process returns to S5.2.1 where the signals 15₁, 15₂ are updated.

Process Including Non-Linear Filtering

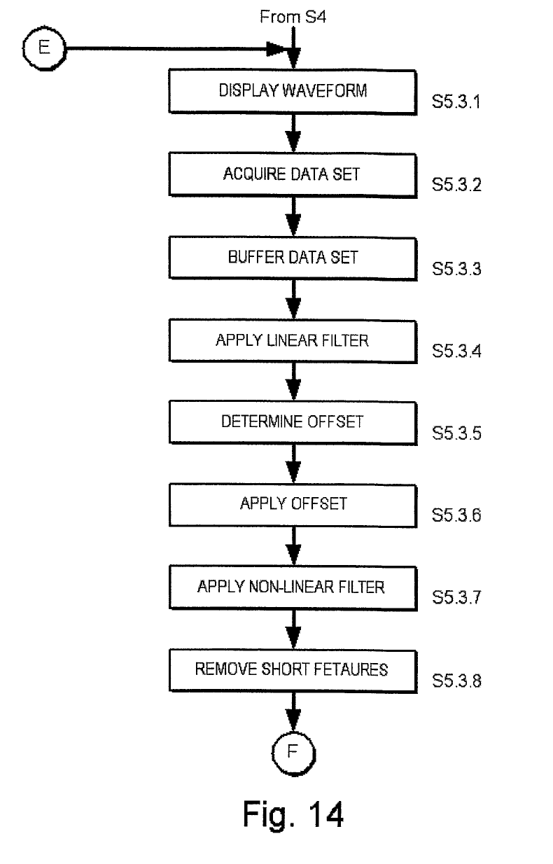

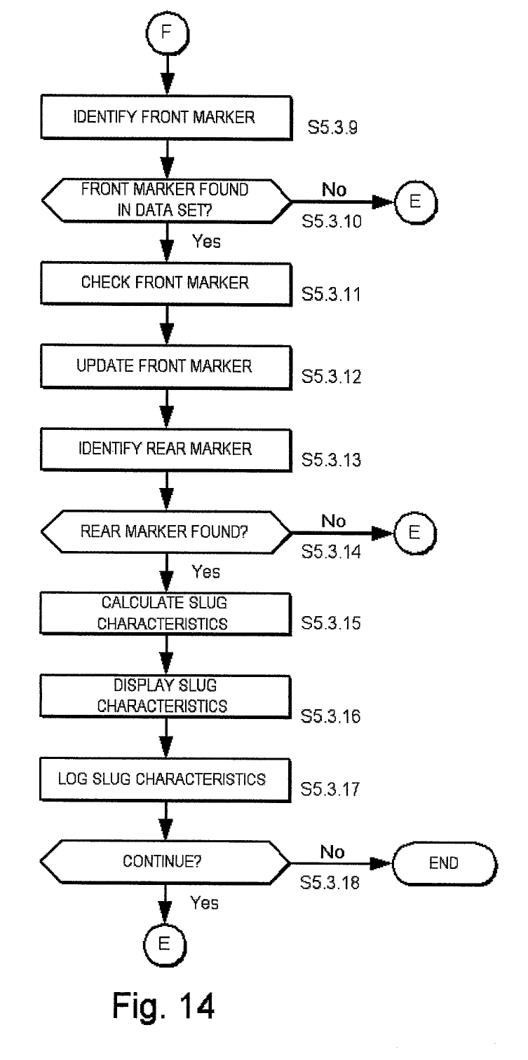

Referring to FIG. 14, a third process for detecting slugs is shown.

For each signal 15₁, 15₂, a graphical representation 30₁, 30₂is displayed (step S5.3.1). A further predetermined number of samples 15₁′, 15₂′ of the signals 15₁, 15₂, herein referred to as a data set, are acquired and added to the end of each respective buffer 40₁, 40₂ (steps S5.3.2 & S5.3.3). A corresponding number of samples are deleted from the end of each buffer 40₁, 40₂. In this example, the data set comprises 10 samples.

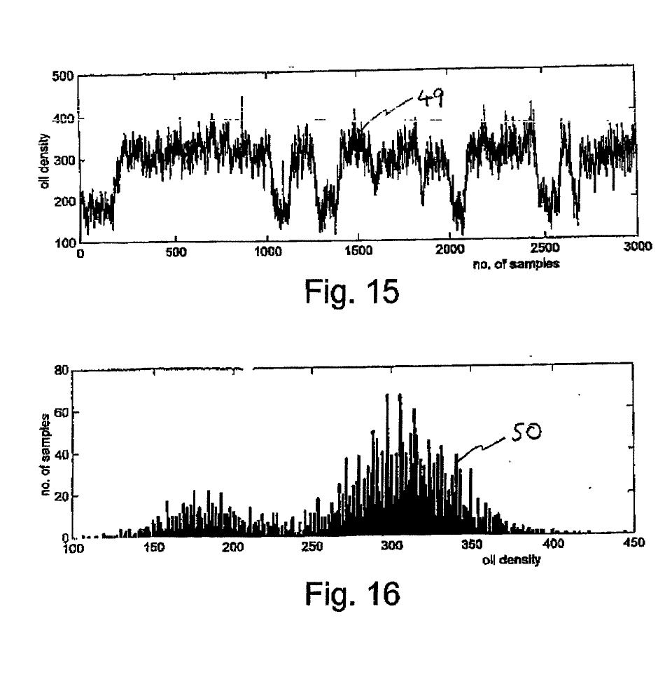

For each buffer 40₁, 40₂, a signal 15 is processed before slug detection occurs. A representation 49 of a signal 15 held in a buffer 40 before processing is shown in FIG. 15 and a corresponding distribution 50 of values of density in the buffer 40 is shown in FIG. 16 (step 5.3.4).

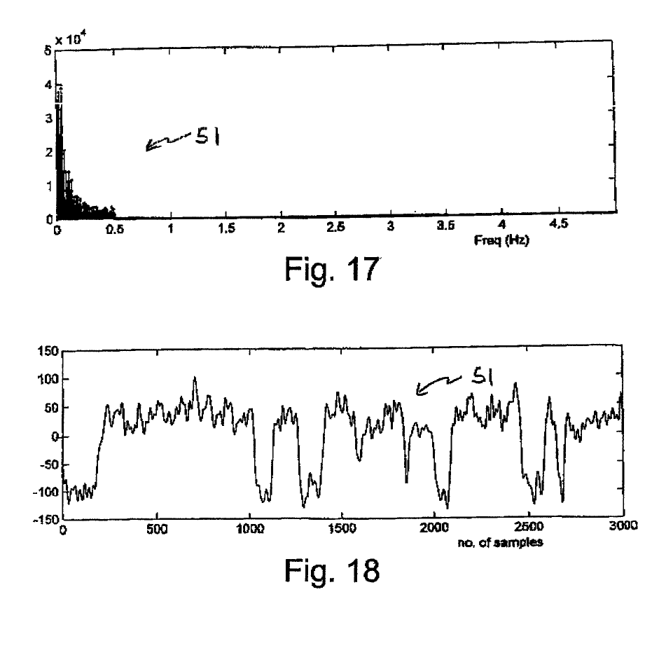

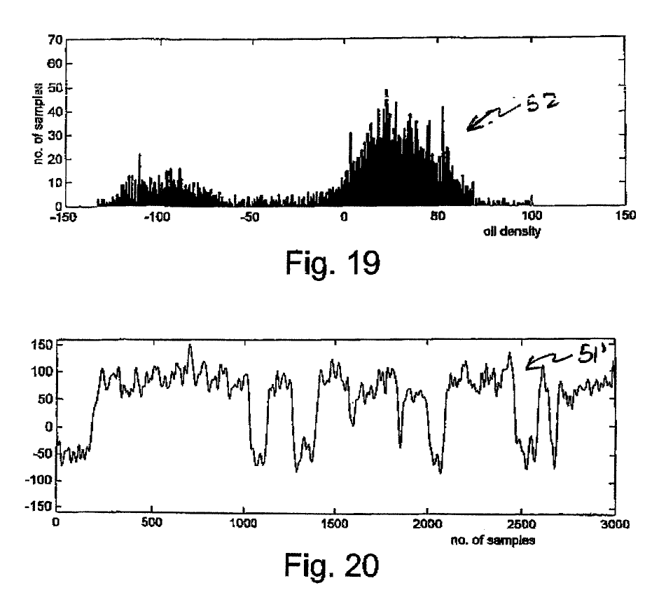

Referring to FIGS. 17 and 18, the signal 15 is filtered using a low-pass, 8^{th} order Butterworth filter with a 0.5 Hz cut-off (step S5.3.4). The filtered signal 51 is shown in the frequency- and time-domains. A corresponding bipolar distribution 52 of the filtered signal 51 is shown in FIG. 19.

A density offset is calculated in a similar manner to calculation of density offset 46 and which is subtracted from the filtered signal (step S5.3.5 & S5.3.6).

The density offset is removed from the linearly filtered signal 51, which is unipolar, to create a bipolar filtered signal 51′ (FIG. 20) having the same density range.

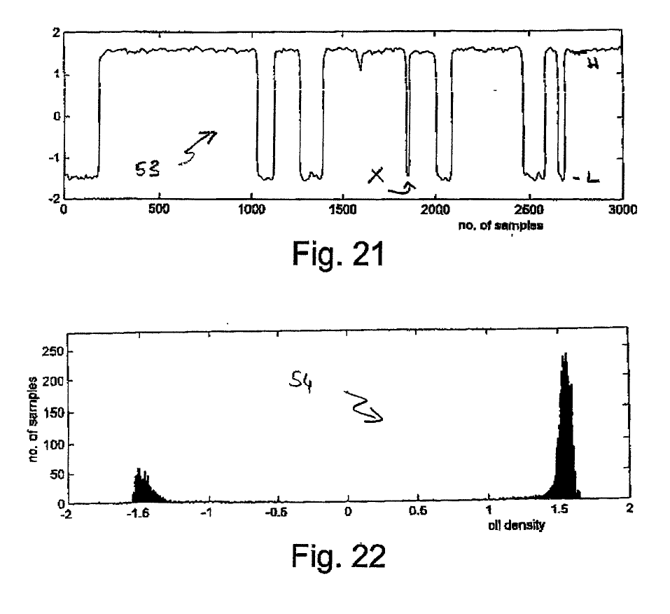

Referring to FIG. 21, the bipolar linearly filtered signal 51′ is non-linearly filtered by taking the 10^{th} root of the modulus of the signal 51′ and retaining the sign to produce a non-linearly filtered signal 53 (step S5.3.7). A corresponding density distribution 54 of the non-linearly filtered signal 53 is shown in FIG. 22.

Referring to FIG. 21, the non-linearly filtered signal 53 appears as a pseudo-binary signal having a high state H and a low state L. However, the signal 53 includes a short duration feature X. The signal 53 is further processed to remove short features, such as feature X (step S5.3.8).

Zero crossings are identified. The duration between adjacent zero crossings is determined. If the duration is less than a predetermined value, for example 25 samples, then the region between the zero-crossings is considered to be a short feature. The short feature is removed by determining sign and amplitude of the portion of signal 53 between the adjacent zero-crossings and adding a further signal of opposite sign and same magnitude to said signal portion.

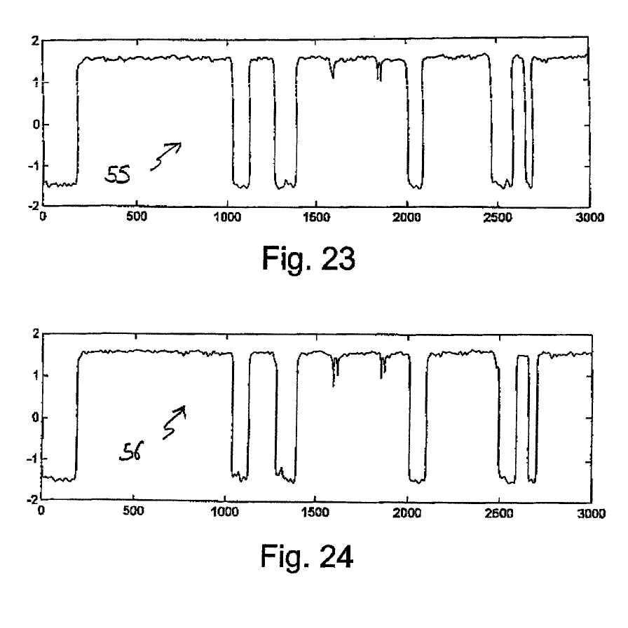

Referring to FIG. 23, a processed signal 55 is shown from which feature X has been removed.

Each signal 15₁, 15₂ is processed in the manner hereinbefore described to obtain a binary signal.

The front and rear of the slug are detected in a manner substantially similar that described in steps S5.2.8 to S5.2.18 (steps S5.3.9 to S 5.3.18).

Referring to FIG. 23 and 24, examples of pseudo binary signals 55, 56 obtained using the non-linear filtering process using first and second signal 15₁, 15₂ from measurement devices 11₁, 11₂ separated along a pipe 1 (FIG. 1) are shown. The signals 55, 56 show a delay in signal transition. Table I below tabulates values at which transitions occur for the first and second signals 15₁, 15₂ and a corresponding difference from which slug velocity may be calculated.

TABLE I

| Channel 1 | Channel 2 | Difference |
|---|---|---|
| 2 | 3 | −1 |
| 182 | 188 | −6 |
| 1027 | 1036 | −9 |
| 1123 | 1126 | −3 |
| 1265 | 1281 | −16 |
| 1388 | 1394 | −6 |
| | 1593 | |
| | 1616 | |
| 1843 | 1853 | −10 |
| 1860 | 1871 | −11 |
| 2001 | 2007 | −3 |
| 2088 | 2100 | −12 |
| 2466 | 2496 | −30 |
| 2583 | 2592 | −9 |
| 2652 | 2659 | −7 |
| 2691 | 2703 | −12 |

It will be appreciated that many modifications may be made to the embodiment described above.

1. A method of detecting a boundary of fluid flowing through a pipe, the method comprising:
receiving a time-varying signal corresponding to changes in content flowing through the pipe; and
analysing said time-varying signal in the time domain, said analysing including processing said time-varying signal to produce a processed signal, searching said processed signal for a predetermined feature so as to identify a location of a boundary if said predetermined feature is found.

2. A method according to claim 1, further comprising
receiving another signal corresponding to changes in content flowing through the pipe; and
analysing said another signal in the time domain, said analysing including processing said another signal to produce another processed signal, searching said another processed signal for another predetermined feature so as to identify another location of another boundary if said another predetermined feature is found.

3. A method according to claim 2, wherein receiving of said time-varying signal and said another signal comprises arranging first and second devices separated by a known distance from one another for producing said time-varying and said another signals at positions along the pipe.

4. A method according to claim 3, further comprising:
deriving a velocity of said boundary and said another boundary from said first and second locations.

5. A method according to claim 1, wherein processing said time-varying signal comprises amplifying to produce an amplified signal.

6. A method according to claim 5, wherein processing said time-varying signal further comprises smoothing said amplified signal to produce a smoothed signal.

7. A method according to claim 6, wherein processing said time-varying signal further comprises differentiating said smoothed signal to produce a differentiated signal.

8. A method according to claim 7, wherein processing said time-varying signal further comprises further amplifying said differentiated signal to produce said processed signal.

9. A method according to claim 8, wherein said further amplifying said differentiated signal comprises squaring said differentiated signal while preserving the sign of the differentiated signal.

10. A method according to claim 9, wherein searching for the predetermined feature includes identifying locations where said processed signal crosses an axis.

11. A method according to claim 10, wherein searching for the predetermined feature includes dividing said processed signal into periods between said locations where said processed signal crosses an axis.

12. A method according to claim 11, wherein searching for the predetermined feature includes determining a maximum magnitude value for the processed signal in each respective period.

13. A method according to claim 12, wherein searching for said predetermined feature includes determining a standard deviation of said maximum magnitude values.

14. A method according to claim 13, wherein searching for said predetermined feature includes identifying which of said maximum magnitude values exceed the standard deviation.

15. A method according to claim 14, comprising identifying a first boundary if said predetermined feature is found.

16. A method according to claim 15, further comprising determining whether the first boundary is found within a predetermined time window.

17. A method according to claim 16, further comprising determining whether said first boundary meets a predefined set of criteria.

18. A method according to claim 17, comprising searching for a second predetermined feature.

19. A method according to claim 18, wherein searching for said second predetermined feature comprises determining a threshold magnitude.

20. A method according to claim 19, wherein searching for said second predetermined feature comprises identifying where the magnitude of said processed signal exceeds the threshold magnitude.

21. A method according to claim 20, comprising identifying a second boundary if said second predetermined feature is found.

22. A method according to claim 21, further comprising determining whether said second boundary precedes the first boundary.

23. A method according to claim 1, wherein processing of said time-varying signal comprises converting an analog signal into a digital signal.

24. A method according to claim 23, further comprising buffering samples of said digital signal.

25. A method according to claim 1, wherein analysing of said time-varying time-varying signal comprises using a time-encoded signal processing and recognition (TESPAR) process.

26. A method according to claim 1, wherein processing said signal comprises filtering said signal to produce a filtered signal.

27. A method according to claim 26, wherein said filtering comprises using a Savitzky Golay filter.

28. A method according to claim 27, wherein processing said time-varying signal comprises subtracting an offset from the filtered signal so as to produce a signal for zero-crossing analysis.

29. A method according to claim 28, wherein searching said processed signal for said predetermined feature includes identifying locations where said time-varying signal has zero amplitude.

30. A method according to claim 29, wherein searching for said processed signal for said predetermined feature includes identifying said locations where said time-varying signal has zero amplitude.

31. A method according to claim 30, wherein searching for said processed signal for said predetermined feature further includes identifying whether said time-varying signal is going from negative to positive.

32. A method according to claim 31, wherein identifying said location comprises identifying a first boundary if said predetermined feature is found.

33. A method according to claim 32, further comprising determining whether the first boundary is found within a predetermined time window.

34. A method according to claim 33, further comprising determining whether said first boundary meets a predefined set of criteria.

35. A method according to claim 34, comprising searching for a second predetermined feature.

36. A method according to claim 35, wherein searching for the second predetermined feature comprises identifying locations where said time-varying signal has zero amplitude.

37. A method according to claim 36, further comprising identifying a second boundary if said second predetermined feature is found.

38. A method according to claim 37, further comprising determining whether said second boundary precedes the first boundary.

39. A method according to claim 38, wherein searching for said processed signal for said predetermined feature further includes identifying whether said signal is going from positive to negative.

40. A method according to claim 1, wherein processing said time-varying signal includes determining a distribution of magnitudes of said time signal.

41. A method according to claim 1, wherein processing said time-varying signal includes filtering to produce a filtered signal.

42. A method according to claim 41, wherein the filtering comprises linear filtering.

43. A method according to claim 42, wherein filtering comprises low-pass filtering.

44. A method according to claim 43, wherein filtering comprises using a low-pass, 8^{th} order Butterworth filter with an 0.5 Hz cut-off.

45. A method according to claim 44, wherein processing said time-varying signal includes determining a distribution of magnitudes of said filtered signal.

46. A method according to claim 45, wherein processing said time-varying signal includes determining an offset for converting said distribution from being unipolar to being bipolar.

47. A method according to claim 46, wherein processing said time-varying signal includes subtracting said offset from the filtered signal to produce an offset signal.

48. A method according to claim 47, wherein processing said time-varying signal includes filtering said offset signal.

49. A method according to claim 48, wherein filtering said offset signal comprises using a non-linear filter to produce said filtered signal.

50. A method according to claim 49, wherein filtering said offset signal comprises using a 10^{th} order non-linear filter.

51. A method according to claim 50, wherein processing of said time-varying signal to produce the processed signal comprises removing features from said filtered signal having a short time duration.

52. A method according to claim 51, wherein removing said features from said filtered signal comprises searching said filtered signal and identifying locations where said filtered signal has zero amplitude.

53. A method according to claim 52, wherein removing said features further includes determining the duration between adjacent locations where said filtered signal has zero amplitude.

54. A method according to claim 53, wherein removing said features further includes determining sign and amplitude of a signal portion between adjacent locations and adding a further signal of opposite sign and same magnitude to said signal portion if said adjacent locations are separated by less than a predetermined duration.

55. A method according to claim 54, wherein searching said processed signal for said predetermined feature includes identifying locations where said processed signal has zero amplitude.

56. A method according to claim 55, wherein searching for said predetermined feature includes identifying said locations where said processed signal has zero amplitude.

57. A method according to claim 56, wherein searching for said predetermined feature further includes identifying whether said processed signal is going from negative to positive.

58. A method according to claim 57, wherein identifying said location comprises identifying a first boundary if said predetermined feature is found.

59. A method according to claim 58, further comprising determining whether the first boundary is found within a predetermined time window.

60. A method according to claim 59, further comprising determining whether said first boundary meets a predefined set of criteria.

61. A method according to claim 60, comprising searching for a second predetermined feature.

62. A method according to claim 61, wherein said searching for a second predetermined feature comprises identifying said locations where said processed signal has zero amplitude.

63. A computer program for executing the method of claim 1.

64. Apparatus for detecting a boundary of fluid flowing through a pipe, the apparatus comprising:
a sensor for receiving a time-varying signal corresponding to changes in content flowing through the pipe; and
a processor for analysing said time-varying signal in the time domain, said processor being configured to produce a processed signal, to search said processed signal for a predetermined feature so as to identify a location of said boundary if said predetermined feature is found.
